(19) United States
(12) Patent Application Publication
(10) Pub. No.: US 2026/0320205 A1
(43) Pub. Date: Oct. 15, 2026

(54) DATA PROCESSING METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Chenyu HUANG, Shenzhen (CN); Peng CHEN, Shenzhen (CN); Xiaofeng YANG, Shenzhen (CN); Danqing HUANG, Shenzhen (CN); Fan ZHANG, Shenzhen (CN); Huaming RAO, Shenzhen (CN)

(21) Appl. No.: 19/702,716

(22) Filed: Jun. 9, 2026

Related U.S. Application Data
(63) Continuation of application No. PCT/CN2025/080397, filed on Mar. 4, 2025.

(30) Foreign Application Priority Data
Mar. 18, 2024 (CN) 202410307489.0

(51) Int. Cl. G06F 21/60

(52) U.S. Cl. CPC G06F 21/602

(57) ABSTRACT

A data processing method is performed by a first device and includes generating first data feature information based on first data using a first model, the first data feature information being configured for characterizing a data feature of the first data; adding noise information to the first data feature information, to obtain second data feature information; and transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

### CROSS-REFERENCES TO RELATED APPLICATIONS

This application is a continuation application of PCT Patent Application No. PCT/CN2025/080397, filed on Mar. 4, 2025, which claims priority to Chinese Patent Application No. 2024103074890, filed on Mar. 18, 2024, all of which is incorporated herein by reference in their entirety.

### FIELD OF THE TECHNOLOGY

The present disclosure relates to the field of artificial intelligence technologies, and in particular, to data security technology.

### BACKGROUND OF THE DISCLOSURE

In computer modeling technology, a data provider can supply data to a model provider for use as model input, and the model provider then processes this input data through a model to generate a model output, which is subsequently returned to the data provider for utilization.

In a related art, a data provider may split data into a plurality of data shards, retain some of the data shards, and transmit some other data shards to the model provider. The data provider and the model provider separately input respective data shards into a model, to generate corresponding output results. Finally, the output results obtained by the data provider and the model provider are spliced and reconstructed to provide an output result corresponding to the complete input data. Throughout this process, because the model provider is unable to access the complete input data, security of the data provided by the data provider is ensured.

However, the methods in the related art greatly increases computational workload required for computational workload data processing performed by using a model, greatly reduces data processing efficiency, and are difficult to be widely applied to various data processing scenarios.

### SUMMARY

One embodiment of the present disclosure provides a data processing method performed by a first device. The method includes generating first data feature information based on first data using a first model, the first data feature information being configured for characterizing a data feature of the first data; adding noise information to the first data feature information, to obtain second data feature information; and transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

Another embodiment of the present disclosure provides an electronic device used as a first device. The electronic device includes one or more processors and a memory containing a computer program that, when being executed, causes the one or more processors to perform: generating first data feature information based on first data using a first model, the first data feature information being configured for characterizing a data feature of the first data; adding noise information to the first data feature information, to obtain second data feature information; and transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

Another embodiment of the present disclosure provides a non-transitory computer readable storage medium containing a computer program that, when being executed, causes at least one processor to perform: generating first data feature information based on first data using a first model, the first data feature information being configured for characterizing a data feature of the first data; adding noise information to the first data feature information, to obtain second data feature information; and transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

### BRIEF DESCRIPTION OF THE DRAWINGS

To more clearly describe the technical solutions in embodiments of the present disclosure or the related art, the following briefly introduces the accompanying drawings required for describing the embodiments and the existing technology. Clearly, the accompanying drawings in the following description are merely some embodiments of the present disclosure, and a person of ordinary skill in the art may still derive other drawings from these accompanying drawings without creative efforts.

FIG. 1 is a schematic diagram of a data processing method in an actual application scenario according to an embodiment of the present disclosure.

FIG. 2 is a diagram of signaling of a data processing method according to an embodiment of the present disclosure.

FIG. 3 is a diagram of signaling of a data processing method according to an embodiment of the present disclosure.

FIG. 4 is a schematic diagram of a data processing method according to an embodiment of the present disclosure.

FIG. 5 is a diagram of signaling of a data processing method according to an embodiment of the present disclosure.

FIG. 6 is a diagram of signaling of a data processing method in an actual application scenario according to an embodiment of the present disclosure.

FIG. 7 is a schematic diagram of a data processing method in an actual application scenario according to an embodiment of the present disclosure.

FIG. 8 is a block diagram of a structure of a data processing apparatus according to an embodiment of the present disclosure.

FIG. 9 is a block diagram of a structure of a data processing apparatus according to an embodiment of the present disclosure.

FIG. 10 is a diagram of a structure of a terminal according to an embodiment of the present disclosure.

FIG. 11 is a diagram of a structure of a server according to an embodiment of the present disclosure.

### DESCRIPTION OF EMBODIMENTS

Embodiments of the present disclosure are described below with reference to the accompanying drawings.

Data processing based on a model has a wide range of application scenarios. For example, in an artificial intelligence scenario, a corresponding text information processing result may be obtained based on input text information by using a model. A data provider and a model provider usually need to participate in data processing. The data provider is configured to provide data for being inputted into a data processing model, to obtain a processing result corresponding to the data. The model provider is configured to provide the data processing model, to complete a data processing procedure for the data by using the data processing model.

In a related art, to ensure data security of the data provider and prevent the model provider from obtaining complete input data, the data provider may split data that needs to be inputted into two parts, which are respectively inputted by the data provider and the model provider into a model for processing. Finally, results are concatenated, to obtain a data processing result corresponding to the complete data.

However, in the data processing manner in the related art, one time of data processing originally performed on the complete data is converted into two times of data processing performed on two data parts. Consequently, a computational workload in a data processing process is greatly increased. Although the data security of the data provider can be ensured to some extent, data processing efficiency is greatly reduced, and it is difficult to provide an efficient data processing service. As a result, it is difficult for the manner to be applicable to a plurality of scenarios having a high requirement on the data processing efficiency.

To resolve the foregoing technical problem, the present disclosure provides a data processing method. A data processing model is split into a first model on a data input side and a second model on a data output side. A first device used as a data provider may generate first data feature information based on first data used as input data by using the first model, and then adds noise information to the first data feature information, to obtain second data feature information. A second device used as a model provider may obtain a first data processing result based on the second data feature information by using the second model, the first data processing result being configured for characterizing a data processing result obtained by processing the first data by using the data processing model. Because the data provider can obtain only a part of the model, security of the model provided by the model provider is ensured. Because the second data feature information has the noise information, the second device cannot restore the first data by using the second data feature information, and data security of the data provider is ensured. Meanwhile, because the noise information affects the data processing procedure on the output side, interference to the data processing result is small, and accuracy of the obtained first data processing result is high. In addition, the entire data processing procedure does not need to be repeatedly executed in the present disclosure, so that a computational workload required for the entire data processing process is small, and data processing efficiency is high. In conclusion, in the present disclosure, data security and model security can be considered while ensuring data processing accuracy and data processing efficiency, to bring a better data processing effect.

The method may be performed by a computer device, and the computer device is a computer device having a data processing function, for example, may be a terminal device or a server. The method may be independently performed by the terminal device or the server, or may be applied to a network scenario in which the terminal device communicates with the server and performed by the terminal device and the server in a cooperation manner. The terminal device may be a device such as a mobile phone, a tablet computer, a notebook computer, or a desktop computer. The terminal device may further include a plurality of types of virtual reality devices, for example, may include an augmented reality (AR for short) device such as AR glasses and an AR screen, and may include a virtual reality (VR for short) device such as head-mounted VR glasses. The server may be understood as an application server or a Web server. During actual deployment, the server may be an independent server, a cluster server, a cloud server, or the like.

The present disclosure further relates to technologies in the field of large models, and may specifically relate to model compression and quantization technologies and a model parallel calculation technology in the field of large models.

The model compression and quantization mean helping reduce a model size and accelerate model inference by using compression and quantization technologies, thereby reducing model storage and calculation costs. The model compression usually includes pruning, low-rank decomposition, knowledge distillation, and the like. The model quantization means converting a floating-point number parameter in a model into a fixed-point number parameter or an integer parameter, thereby reducing a model size and accelerating model inference.

The model parallel calculation means allocating calculation tasks of a model to a plurality of computing devices (for example, a CPU, a GPU, and a TPU) for simultaneous calculation, thereby accelerating model training and model inference. Through the model parallel calculation, computing resources can be effectively used, and calculation efficiency and a training speed of the model can be improved.

In the present disclosure, the model compression and quantization technologies are mainly embodied in that data provided by a data provided may be processed by using a compressed or quantized model, thereby accelerating a data processing speed and reducing sizes of models deployed on a first device and a second device. The model parallel calculation is mainly embodied in that a plurality of first devices perform parallel calculation on input data by using first models respectively deployed on the plurality of first devices, or a plurality of second devices perform parallel calculation on input data by using second models respectively deployed on the plurality of second devices, thereby improving data processing efficiency.

For ease of understanding the technical solutions provided in the present disclosure, the data processing method provided in the present disclosure is described below with reference to an actual application scenario.

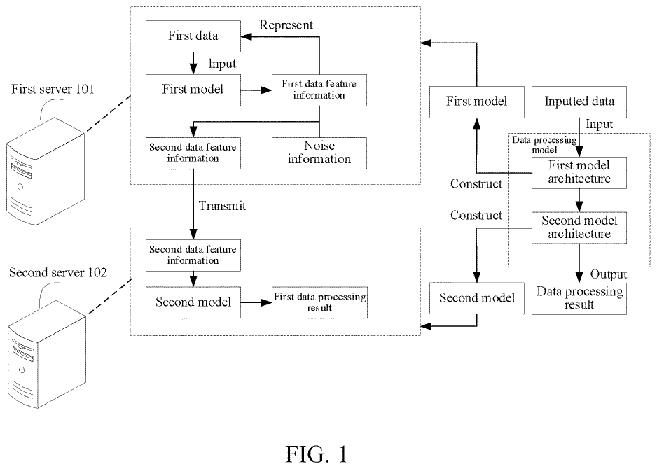

FIG. 1 is a schematic diagram of a data processing method in an actual application scenario according to an embodiment of the present disclosure. In the actual application scenario, a first device is a first server 101, a second device is a second server 102, the first server 101 is a server used as a data provider, and the second server 102 is a server used as a model provider.

A model architecture of a data processing model configured for performing data processing may be split into a first model architecture and a second model architecture. The first model architecture is close to an input side and configured for constructing a first model, and the second model architecture is close to an output side and configured for constructing a second model. The model provider may transmit the first model to the first server 101, and the first server 101 may process first data by using the first model, to obtain first data feature information. The first data feature information is configured for characterizing a data feature corresponding to the first data. The first server 101 may add noise information to the first data feature information, to obtain second data feature information, and then transmit the second data feature information to the second server 102. Because the second data feature information has the noise information, the second server 102 cannot obtain the first data feature information, and therefore cannot restore the first data, thereby ensuring data security of the data provider.

The second server 102 may determine a first data processing result based on the second data feature information by using the second model. Because the first data is processed by using the first model and the second model, and the first model and the second model can form a complete model architecture corresponding to the data processing model, the first data processing result may be configured for characterizing a data processing result obtained by processing the first data by using the data processing model.

According to a first aspect, security of the data provided by the first server 101 can be ensured in the manner as described above. According to a second aspect, because the first server 101 can obtain only a part of the model architecture and cannot restore a complete data processing model, security of the model provided by the second server 102 is ensured. According to a third aspect, the noise information is added after the first data is processed by using the first model in the present disclosure. Therefore, the noise information acts on only a data processing procedure on a data output side, and has small impact on the data processing procedure, so that the first data processing result is close to the data processing result obtained by directly processing the first data by using the data processing model, with high accuracy. According to a fourth aspect, in the present disclosure, the data processing procedure does not need to be repeatedly executed for the first data, a computational workload required for the entire data processing procedure is small, and data processing efficiency is high.

Next, the data processing method provided in the present disclosure is described in detail with reference to the accompanying drawings.

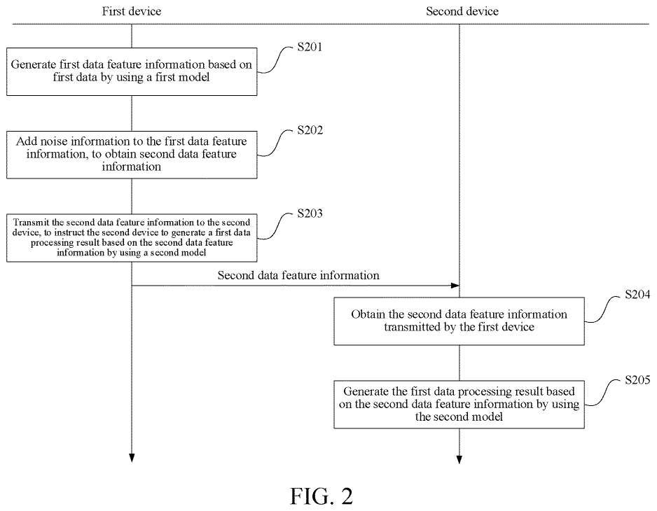

FIG. 2 is a diagram of signaling of a data processing method according to an embodiment of the present disclosure. In this embodiment, a computer device may include a first device used as a data provider and a second device used as a model provider, and the first device and the second device each may be any computer device having a data processing function. The method includes the following operations.
S201: The first device generates first data feature information based on first data by using a first model.

A model provided by the model provider is mainly embodied in two dimensions: a model architecture and a model parameter. For example, for a data processing model, the model architecture can represent a processing procedure of performing data processing, and the model parameter can determine a specific manner of performing data processing based on the processing procedure. Both the model architecture and the model parameter are obtained by the model provider through model development.

Based on this, in this embodiment, to ensure model security of the model provider and prevent the model architecture and the model parameter from being completely obtained by the first device used as the data provider, a model architecture of the data processing model may be first split, to obtain a first model architecture on a data input side and a second model architecture on an output side. The first model architecture is configured for determining data feature information corresponding to input data, and the data feature information is configured for characterizing the input data. The second model architecture is configured for determining a data processing result based on the data feature information, and the first model architecture and the second model architecture can be combined to implement a complete data processing function of the data processing model.

The first model may be formed by using the first model architecture, and a second model may be formed by using the second model architecture. In this embodiment, only the first model is provided for the first device, and the first device used as the data provider cannot obtain a complete model architecture and a complete model parameter, and therefore cannot independently construct the data processing model, thereby ensuring security of the data processing model.

The first device may generate the first data feature information based on the first data by using the first model. The first data feature information is configured for characterizing a data feature of the first data, and the first model corresponds to the first model architecture.
S202: The first device adds noise information to the first data feature information, to obtain second data feature information.

To ensure that the second device used as the model provider cannot obtain accurate input data, the first device may add the noise information to the first data feature information, to generate the second data feature information, thereby ensuring that the second device cannot restore the accurate first data based on the second data feature information. There may be a plurality of types of noise information, for example, the noise information may be Gaussian distribution noise information. This is not limited herein.
S203: The first device transmits the second data feature information to the second device, to instruct the second device to generate a first data processing result based on the second data feature information by using the second model.

The second model corresponds to the second model architecture, and the first model architecture and the second model architecture are configured for forming the model architecture corresponding to the data processing model. The first data processing result is configured for characterizing a data processing result obtained by processing the first data by using the data processing model.
S204: The second device obtains the second data feature information transmitted by the first device.

The second data feature information is obtained by adding the noise information to the first data feature information by the first device, and the first data feature information is generated by the first device based on the first data by using the first model.
S205: The second device generates the first data processing result based on the second data feature information by using the second model.

Because the first model architecture and the second model architecture can form the complete model architecture of the data processing model, and the first data processing result is obtained by performing data processing of the first model, noise addition, and data processing of the second model on the first data, a difference between the first data processing result and a data processing result obtained by directly processing the first data by using the data processing model lies only in impact of the noise information, so that the first data processing result may be configured for characterizing the data processing result obtained by processing the first data by using the data processing model.

Generally, a longer data processing procedure in which the noise information participates indicates larger impact on a data processing result. A data processing procedure is affected by the noise information earlier on the data input side, impact on input data is larger, and impact on a data processing result is larger. Conversely, the data processing procedure is affected by the noise information later on the data output side, impact on the input data is smaller, and impact on the data processing result is smaller. Therefore, in the present disclosure, after processing is performed by using the first model, the noise information is added, so that the noise information affects only a data processing part of the second model on the output side. This reduces the impact of the noise information on the first data, and reduces the impact on the data processing result, so that the first data processing result can be close to a real data processing result and data processing accuracy is ensured.

In the foregoing technical solution, security of the data provided by the data provider and security of the model provided by the model provider are ensured in the present disclosure, and the impact of the noise information on the data processing result is reduced, so that the finally obtained first data processing result is close to an actual data processing result obtained by directly processing the first data by using the data processing model, thereby ensuring accuracy of data processing. In addition, the data processing procedure does not need to be repeated for a plurality of times on a single device in the present disclosure. For example, on the second device, a data processing procedure corresponding to the second model needs to be performed only once, or on the first device, a data processing procedure corresponding to the first model needs to be performed only once. A computational workload required for the entire data processing process is small, and data processing efficiency is ensured, so that the data processing method in the present disclosure is applicable to a wider range of data processing scenarios.

As described above, the model includes the model architecture and the model parameter. Although according to the foregoing method, the complete model architecture and the complete model parameter can be split as a whole, the first model in the first device may still include a complete model parameter corresponding to the data processing model on the first model architecture. In one embodiment, the computer device may further process a model parameter corresponding to the first model architecture, to prevent the data provider from obtaining the complete model parameter corresponding to the first model architecture.

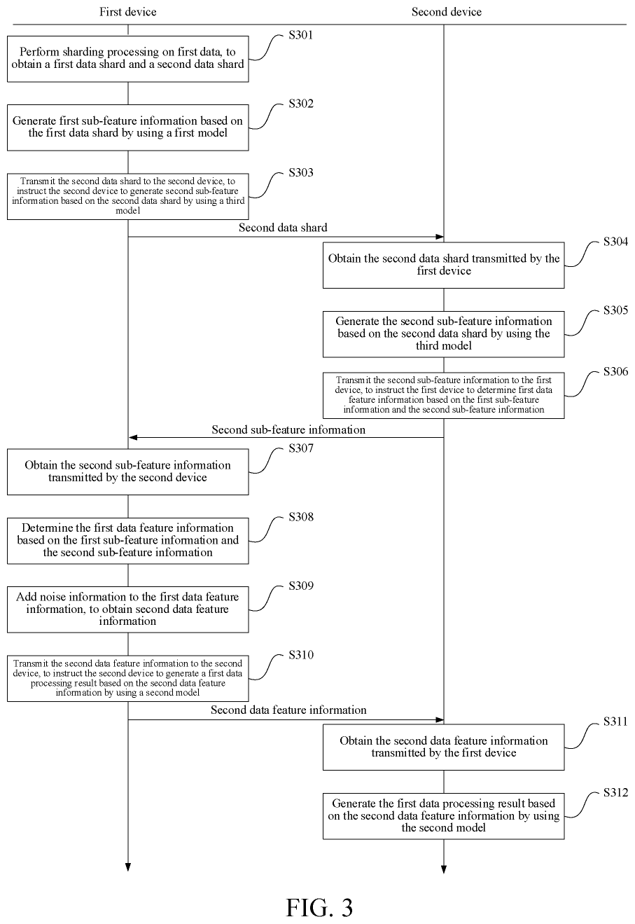

FIG. 3 is a diagram of signaling of a data processing method according to an embodiment of the present disclosure. Operation S301 to operation S303, and operation S307 and operation S308 are a possible implementation of operation S201. The method includes the following operations.
S301: A first device performs sharding processing on first data, to obtain a first data shard and a second data shard.

Data sharding means splitting data into a plurality of data parts, and each of the data parts may be used as a data shard. In the present disclosure, the first data may be split into two data shards, that is, the first data shard and the second data shard, or may be split into more shards. This is not limited herein. The first data shard and the second data shard may be configured for forming the first data, that is, a combination of the first data shard and the second data shard can include complete data content corresponding to the first data. Therefore, data processing is performed on the first data shard and the second data shard, and a data result of data processing on the first data can be simulated.
S302: The first device generates first sub-feature information based on the first data shard by using a first model.

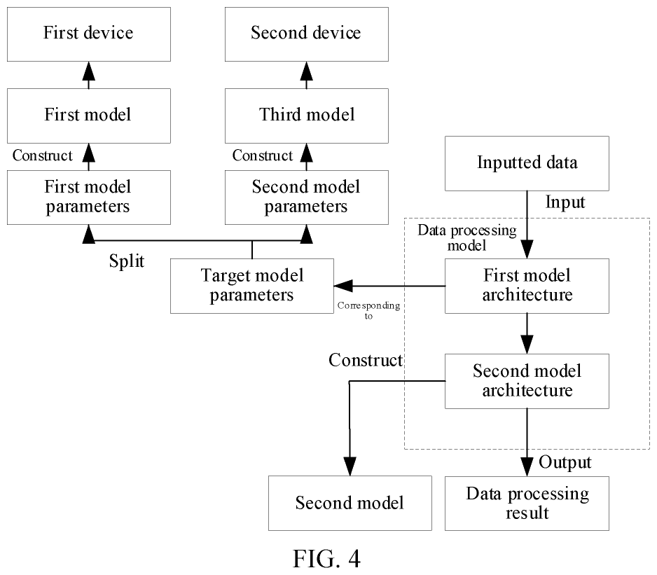

In this embodiment of the present disclosure, to protect security of a model parameter provided by a model provider, as shown in FIG. 4, a target model parameter may be split into a first model parameter and a second model parameter. The target model parameter is a model parameter of a first model architecture in a data processing model. A computer device may allocate the first model parameter to the first model of a data provider, so that the data provider cannot obtain the complete target model parameter, and therefore cannot restore a model part of the first model architecture in the data processing model. The first sub-feature information is configured for characterizing a data feature of the first data shard.
S303: The first device transmits the second data shard to a second device, to instruct the second device to generate second sub-feature information based on the second data shard by using a third model.

The second model parameter may be allocated to the third model. The third model is located in the second device used as the model provider, the third model also corresponds to the first model architecture, and the second sub-feature information is configured for characterizing a data feature of the second data shard.
S304: The second device obtains the second data shard transmitted by the first device.
S305: The second device generates the second sub-feature information based on the second data shard by using the third model.
S306: The second device transmits the second sub-feature information to the first device, to indicate the first device to determine first data feature information based on the first sub-feature information and the second sub-feature information.

As described above, the first sub-feature information is information generated by the first device based on the first data shard by using the first model. The first model has the first model parameter, the first model parameter and the second model parameter are configured for forming the target model parameter, and the model part corresponding to the first model architecture in the data processing model has the target model parameter.
S307: The first device obtains the second sub-feature information transmitted by the second device.
S308: The first device determines the first data feature information based on the first sub-feature information and the second sub-feature information.

Because the first model parameter and the second model parameter may be configured for forming the target model parameter, the first data shard and the second data shard may be configured for forming the first data, and both the first model and the third model correspond to the first model architecture, data processing performed on the first data by using a first model part in the data processing model can be restored with reference to data processing performed on the first data shard by using the first model and data processing performed on the second data shard by using the third model, so that the first data feature information can be determined based on the first sub-feature information and the second sub-feature information.
S309: The first device adds noise information to the first data feature information, to obtain second data feature information.
S310: The first device transmits the second data feature information to the second device, to instruct the second device to generate a first data processing result based on the second data feature information by using a second model.
S311: The second device obtains the second data feature information transmitted by the first device.
S312: The second device generates the first data processing result based on the second data feature information by using the second model.

It can be learned from the foregoing process that in the entire data processing process, the first device used as the data provider does not obtain a complete model parameter corresponding to any model architecture in the data processing model, to further ensure model security of the model provider. In addition, the second device used as the model provider does not obtain the complete first data, to ensure data security of the data provider. In addition, in comparison with the related art, only two times of data processing need to be performed in the first model architecture part in the present disclosure, and the entire data processing procedure does not need to be repeated. Therefore, a computational workload required for the processing process is still reduced to some extent, and data processing efficiency is improved.

A data processing speed of a model is generally related to a data size, and larger data indicates a slower data processing speed. When model architectures of the first model and the third model are the same, that is, when data processing procedures are the same, the data size determines a data processing speed of the first model and a data processing speed of the third model. Therefore, in one embodiment, because the first data feature information can be obtained through synthesis only after both processing of the first model and processing of the third model are completed, to avoid a problem that due to different data sizes, a model that is configured for processing a large data shard in the first model and the third model has not completed processing and the other model has completed processing, causing waiting, the first device may enable the first data shard and the second data shard to have a same data size, so that an overall optimal data processing speed can be brought, thereby ensuring data processing efficiency.

In the foregoing process, data of the data provider is mainly protected in an input data dimension. In another possible implementation, a data processing result outputted by a model may be further protected in the present disclosure, to prevent a party other than the data provider from obtaining the data processing result.

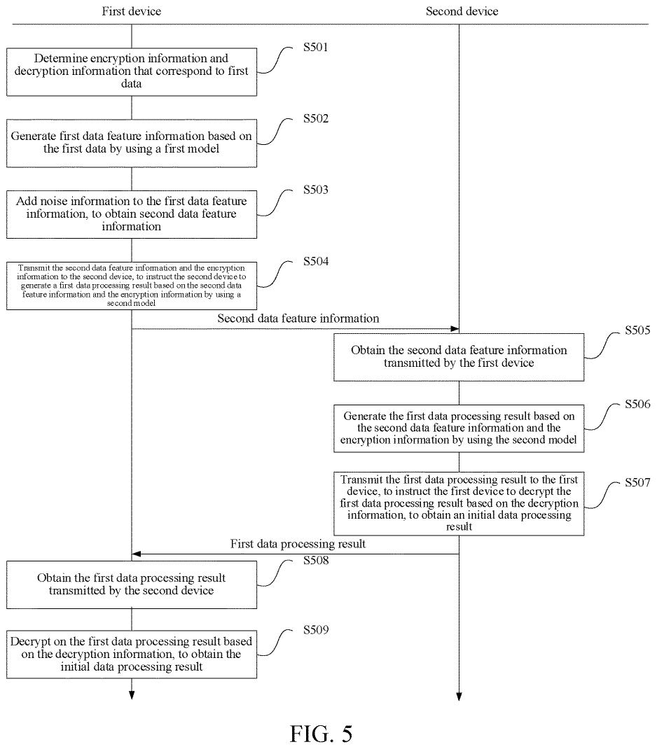

FIG. 5 is a diagram of signaling of a data processing method according to an embodiment of the present disclosure. Operation S504 is a possible implementation of operation S203, and operation S505 is a possible implementation of operation S204. The method includes the following operations.
S501: A first device determines encryption information and decryption information that correspond to first data.

The encryption information is configured for characterizing an encryption manner of a data processing result corresponding to the first data, and the decryption information is configured for decrypting data obtained through encryption in the encryption manner. There may be a plurality of encryption manners. This is not limited herein.
S502: The first device generates first data feature information based on the first data by using a first model.
S503: The first device adds noise information to the first data feature information, to obtain second data feature information.
S504: The first device transmits the second data feature information and the encryption information to a second device, to instruct the second device to generate a first data processing result based on the second data feature information and the encryption information by using a second model.

When transmitting the second data feature information to the second device, the first device may also transmit the encryption information to the second device. In this way, the second model in the second device may encrypt, based on the encryption information, a data processing result obtained through processing, and finally output the encrypted first data processing result, so that a model provider cannot obtain an accurate data processing result, and data security of a data provider is ensured from an output side.
S505: The second device obtains the second data feature information and the encryption information that are transmitted by the first device.
S506: The second device generates the first data processing result based on the second data feature information and the encryption information by using the second model.

The second device may generate an initial data processing result based on the second data feature information by using the second model, and encrypt the initial data processing result based on the encryption information, to output the first data processing result. The initial data processing result is a data processing result obtained by performing data processing on the second data feature information. An objective of this embodiment of the present disclosure is to protect the data processing result from being obtained by the model provider.

An input of the second model is the second data feature information, and an output is the first data processing result. After the initial data processing result is obtained, the initial data processing result is not outputted, but an encryption procedure is directly performed. Therefore, the second device cannot obtain the initial data processing result. Because the decryption information is held by the first device, the second device cannot decrypt the first data processing result, thereby ensuring data security.
S507: The second device transmits the first data processing result to the first device, to indicate the first device to decrypt the first data processing result based on the decryption information, to obtain the initial data processing result.
S508: The first device obtains the first data processing result transmitted by the second device.
S509: The first device decrypts the first data processing result based on the decryption information, to obtain the initial data processing result.

When the second model is configured for processing the second data feature information, the initial data processing result obtained in this process is not directly outputted, but the encryption procedure is performed on the initial data processing result, to obtain the encrypted first data processing result. Therefore, the second device cannot obtain the initial data processing result. In addition, the decryption information is held by the first device, and the second device cannot decrypt the first data processing result, so that it is ensured that the second device used as the model provider cannot obtain the data provided by the data provider, thereby ensuring data security.

Next, technical details respectively corresponding to a first device side and a second device side are described in detail.

For the first device side, the present disclosure may be applied to data processing scenarios for a plurality of types of data. Data processing of a text information type is used as an example. In one embodiment, the first device may process text information in the following manner, to obtain first data for being inputted into a model.

The first device may obtain target text information. The target text information is information that needs to be processed by using a data processing model to obtain a data processing result, for example, may be query text information that needs to be inputted into a query model. To enable the data processing model to better understand information composition of the text information, so as to perform data processing more accurately, the first device may perform word segmentation processing on the target text information, to obtain a word segmentation set corresponding to the target text information. The word segmentation set includes a plurality of words (or segmented words). The word may be a character, a word group, a phrase, a short sentence, or the like in the text information. This is not limited herein. A plurality of types of segmentation methods may be used for word segmentation processing, for example, methods such as byte-pair encoding (BPE for short), wordpiece, or sentencepiece may be used. This is not limited herein.

Then, to enable the data processing model to understand meanings of the words, the first device may determine word encodings corresponding to the plurality of words, to convert the text information into encoding information that can be understood by the model. A word encoding is configured for characterizing a corresponding word, and word encodings corresponding to different words are different, so that the words can be effectively represented by using the word encodings. There may be a plurality of encoding schemes for the word encodings, for example, universal character set/unicode transformation format (UTF-8 for short) may be used. This is not limited herein. The first device may generate the first data based on the word encodings respectively corresponding to the plurality of words, so that the data processing model can fully understand information content of the target text information.

To further improve data processing accuracy, in addition to information content corresponding to the words, the first device may further integrate other information that facilitates data processing into the first data.

For example, in one embodiment, when determining the word encodings respectively corresponding to the plurality of words, the first device may not only determine, for each of the plurality of words, a word encoding corresponding to the word, but also determine a segment encoding corresponding to the word. Specifically, the target text information includes text information respectively corresponding to a plurality of units. The unit is a text information unit that can include the plurality of words, for example, a sentence unit, or a paragraph unit. Generally, an association relationship between a plurality of words in the same unit is closer, and an association relationship between words in different units is weaker. Therefore, units to which the plurality of words belong are identified, and an association relationship between the words can be analyzed by using the data processing model, so that more accurate data processing can be performed.

Based on this, the first device may determine, for each of the plurality of words, a segment encoding corresponding to the word. The segment encoding is configured for characterizing a unit in which the word is located. Correspondingly, when generating the first data based on the word encodings respectively corresponding to the plurality of words, the first device may generate the first data based on the word encodings and segment encodings that respectively correspond to the plurality of words, so that the model can clearly learn of the association relationship between the plurality of words based on the segment encodings, thereby improving data processing accuracy.

In addition to a relationship between the units to which the words belong, a position relationship between different words is also an important factor affecting content of text information. When the same word is distributed at different positions of the text information, information content brought by the same word may be different. In addition, a position relationship between the plurality of words can also affect information content of the text information formed by the plurality of words to some extent. Therefore, in another possible implementation, the first device may further determine, for each of the plurality of words, a position encoding corresponding to the word. The position encoding is configured for identifying a position distribution of the word in the target text information, for example, the position encoding may identify the word as a 1^{st} word or a 2^{nd} word in the target text information. When the target text information includes only one unit, the position encoding may directly identify a position relationship of the word in the target text information. When the target text information includes a plurality of units, the position encoding may identify a position relationship of the word in a unit to which the word belongs, for example, position distributions of the plurality of words in the same sentence.

When generating the first data based on the word encodings respectively corresponding to the plurality of words, the first device may generate the first data based on the word encodings and position encodings that respectively correspond to the plurality of words, so that the model can learn of the position relationship between the plurality of words, which helps the model further understand text semantics of the target text information, and further improves data processing accuracy.

As described above, a strong correspondence exists between the words and the word encodings, to be specific, usually, the words and the word encodings are in one-to-one correspondence, to represent uniqueness of each of the words. To further improve data processing efficiency, in one embodiment, an encoding mapping relationship may be constructed, so that the first device can rapidly determine the word encodings based on the encoding mapping relationship.

After determining the word encodings respectively corresponding to the plurality of words, the first device may determine the word encodings respectively corresponding to the plurality of words based on the encoding mapping relationship. The encoding mapping relationship is configured for recording a mapping relationship between a word and a word encoding, so that a word encoding can be determined by searching the simple mapping relationship, thereby simplifying a word encoding determining process. In this way, data processing efficiency can be further improved, and data processing pressure of the first device can be reduced, so that the data processing method of the present disclosure can be applied to more devices with poor data processing performance, thereby expanding versatility of data processing.

Due to a large variety and quantity of words, some words for which word encodings have not been generated may exist, and therefore, the encoding mapping relationship may not include word encodings corresponding to some words. In this case, the first device may generate the word encodings corresponding to such words in another manner, for example, by using an encoding algorithm. To improve the comprehensiveness of the encoding mapping relationship, when the encoding mapping relationship does not include a specific word, the first device may update a mapping relationship between the word and a word encoding into the encoding mapping relationship, so that when a word encoding needs to be generated for the word next time, the word encoding can be directly generated based on the encoding mapping relationship without performing other encoding processing again.

Next, technical descriptions are provided for the second device used as a model provider in detail.

First, because the originally complete model architecture is split into the first model architecture and the second model architecture in the present disclosure, the data processing result may be affected to some extent. Based on this, in one embodiment, when splitting the model architecture, the second device may set a first degree threshold. The first degree threshold is configured for measuring impact of model architecture splitting on data processing accuracy. The second device can ensure that a difference degree between the first data processing result and a second data processing result is less than the first degree threshold. The second data processing result is a data processing result obtained by processing the first data by using the data processing model. To be specific, when splitting the model architecture, the second device can ensure that a data processing result obtained based on a split model architecture is close to a data processing result obtained based on the complete model architecture, thereby ensuring processing accuracy of data processing performed in the manner of the present disclosure.

Specifically, in one embodiment, the second device may split the model architecture in the following manner.

First, the second device may obtain second data. The second data has a corresponding sample data processing result. The sample data processing result is a result obtained by processing the second data by using the data processing model, that is, a data processing result obtained by performing data processing by using the complete model architecture.

The second device may segment a model architecture corresponding to the data processing model in an initial structure segmentation manner, to obtain a first initial model architecture and a second initial model architecture. The first initial model architecture and the second initial model architecture may form the model architecture corresponding to the data processing model. The second device may construct a first initial model and a second initial model. The first initial model architecture is a model architecture corresponding to the first initial model, and the second initial model architecture is a model architecture corresponding to the second initial model, so that data processing performed by using the first initial model and the second initial model can simulate data processing performed by using the data processing model.

The second device may generate third data feature information based on the second data by using the first initial model. The third data feature information is configured for characterizing a data feature corresponding to the second data. Then, the second device may generate a pending data processing result based on fourth data feature information by using the second initial model. The fourth data feature information is obtained by adding the noise information to the third data feature information, so that impact of the noise information on the third data feature information can be represented. The noise information may be added in a plurality of manners. For example, if the noise information needs to be kept as secret, the noise information may be added by the first device, to ensure that the second device cannot restore the data based on the noise information in a subsequent processing procedure. If the noise information does not need to be kept as secret, the noise information may be added by the second device.

In addition, to ensure data processing accuracy during actual application, when a structure segmentation manner is analyzed, applied noise information may be consistent with noise information during actual application, thereby ensuring that degrees of impact of the noise information on a model data processing process are close, and avoiding interference of additional factors.

As described above, the sample data processing result is a processing result obtained by processing the second data based on the complete model architecture, and the pending data processing result is a processing result obtained by processing the second data based on a model architecture obtained by segmenting the complete model architecture. Therefore, a difference between the pending data processing result and the sample data processing result can represent impact of a model architecture obtained through segmentation on data processing accuracy. A smaller difference indicates smaller impact on data processing accuracy when the model architecture is segmented in the initial structure segmentation manner. Therefore, the second device may adjust the initial structure segmentation manner based on the difference, to obtain a structure segmentation manner. A difference degree between the pending data processing result and the sample data processing result that are determined in the structure segmentation manner is less than the first degree threshold, thereby ensuring that after the data processing model is segmented in the structure segmentation manner, the obtained first model and the obtained second model can relatively accurately process the data.

The second device may segment the model architecture corresponding to the data processing model in the structure segmentation manner, to obtain the first model architecture and the second model architecture. The first model architecture may be configured for forming the first model and the third model, and the second model architecture may be configured for forming the second model.

In addition, it can be learned from the foregoing content that the noise information is also one of factors affecting the data processing accuracy. In the present disclosure, an objective of the noise information is to change data, and not to affect a data processing result. Therefore, a type of the noise information may be selected based on a degree of impact of the noise information on the data processing result. In the present disclosure, a second degree threshold may be preset. The second degree threshold is configured for measuring whether the noise information greatly affects a data processing result. The selected noise information meets that the difference degree between the first data processing result and the second data processing result is less than the second degree threshold, and the second data processing result is the data processing result obtained by processing the first data by using the data processing model, so that it can be ensured that addition of the noise information does not cause inaccuracy of the data processing result and does not affect a model use effect of a data provider.

For ease of understanding the technical solutions provided in the present disclosure, the technical solutions provided in the present disclosure are described below with reference to an actual application scenario.

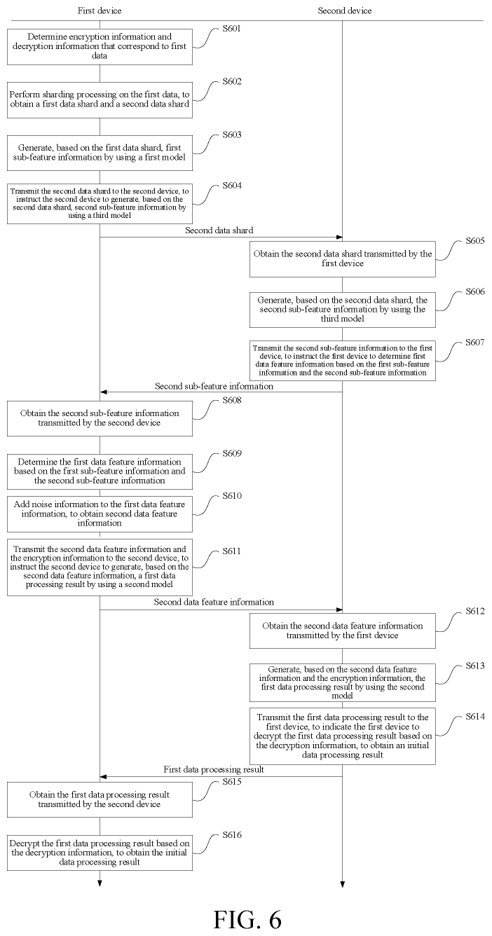

FIG. 6 is a diagram of signaling of a data processing method in an actual application scenario according to an embodiment of the present disclosure. In the actual application scenario, a computer device includes a first device used as a data provider and a second device used as a model provider, and the method includes the following operations.
S601: The first device determines encryption information and decryption information that correspond to first data.

In the present disclosure, original data may be text information, and the first data may be a word encoding result U obtained through word segmentation and encoding processing. Segment encoding information, position encoding information, and the like may be added to U. This is not limited herein.
S602: The first device performs sharding processing on the first data, to obtain a first data shard and a second data shard.

The first device may shard the word encoding result U, to obtain a first data shard

$${〈 U 〉}_{0}^{A}$$

and a second data shared

$${〈 U 〉}_{1}^{A} .$$

The first device holds the

$${〈 U 〉}_{0}^{A}$$

and the second device holds

$${〈 U 〉}_{1}^{A} .$$

In this actual application scenario, data in a format of < >^{A} represents a data shard.

$${〈 〉}_{0}^{A}$$

represents a data shard processed by using a first model.

$${〈 〉}_{1}^{A}$$

represents a data shard processed by using a third model.
S603: The first device generates first sub-feature information based on the first data shard by using the first model.

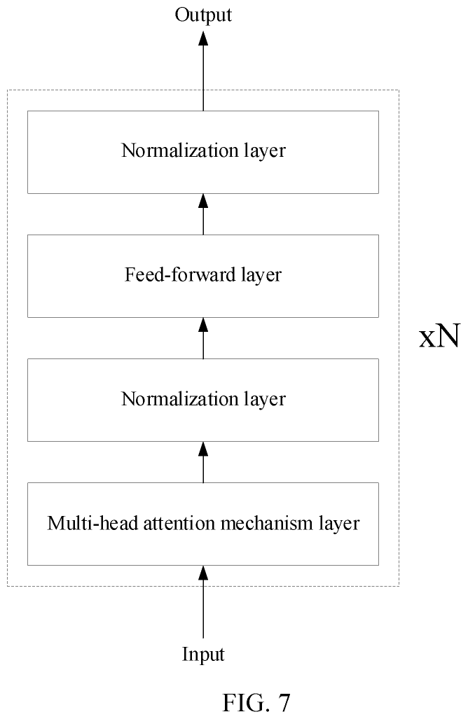

In the present disclosure, a first model architecture may be N cycles of a model architecture shown in FIG. 7. In one cycle, input data sequentially passes through a multi-head attention mechanism layer, a normalization layer, a feedforward layer, and a second normalization layer. Both the first model and the third model correspond to the first model architecture.
S604: The first device transmits the second data shard to the second device, to instruct the second device to generate second sub-feature information based on the second data shard by using the third model.
S605: The second device obtains the second data shard transmitted by the first device.
S606: The second device generates the second sub-feature information based on the second data shard by using the third model.

Functions of the layers in the first model architecture are as follows:
1. Multi-head attention mechanism layer: The multi-head attention mechanism layer is formed by concatenating a plurality of attention mechanism layers, and a processing method is shown in the following formula:

( [symbol] A₀ [symbol] ^{A}∥ [symbol] A₁ [symbol] ^{A}∥ . . . ∥ [symbol] Aₕ [symbol] ^{A}) [symbol] WO [symbol] ^{A}

W0 is a model weight, and each attention is calculated in the following formula:

[symbol]

A [symbol] ^{A}=Attention( [symbol] Q [symbol] ^{A}, [symbol] K [symbol] ^{A}, [symbol] V [symbol] ^{A})=softmax( [symbol] Q [symbol] ^{A} [symbol] K [symbol] ^{A}^{^{T}}+M) [symbol] V [symbol] ^{A}

[symbol] Q [symbol] ^{A}= [symbol] X [symbol] ^{A} [symbol] WQ [symbol] ^{A}, [symbol] K [symbol] ^{A}= [symbol] X [symbol] ^{A} [symbol] WK [symbol] ^{A}, [symbol] V [symbol] ^{A}= [symbol] X [symbol] ^{A} [symbol] WV [symbol] ^{A}, and [symbol] X [symbol] _{A} are data shards inputted into a model, [symbol] WQ [symbol] ^{A}, [symbol] WK [symbol] ^{A}, and [symbol] WV [symbol] ^{A} are all model weights, that is, model parameters. The first model architecture is applied to the first model and the third model, and a model parameter of a data processing model corresponding to the first model architecture may be split into two data shards, that is, a first model parameter and a second model parameter. The first model parameter corresponding to the first model is

$${〈 WQ 〉}_{0}^{A} , {〈 WK 〉}_{0}^{A} , and {〈 WV 〉}_{0}^{A} .$$

The second model parameter corresponding to the third model is

$${〈 WQ 〉}_{1}^{A} , {〈 WK 〉}_{1}^{A} , and {〈 WV 〉}_{1}^{A} . {〈 A 〉}^{A}$$

is an output calculated by using each attention mechanism. Through the multi-head attention mechanism layer, an association relationship between words and entire text information may be strengthened for the model, thereby deepening understanding of the model on the input data.
2. Normalization layer: The following calculations may be respectively performed by using the first model and the third model:

$${〈 μ 〉}^{A} = 1 / H {\sum }_{i = 1}^{H} {〈 {X}_{i} 〉}^{A}$$

$${〈 σ 〉}^{A} = sqrt ( \frac{1}{H} {\sum }_{i = 1}^{H} {( {〈 {X}_{i} 〉}^{A} - μ )}^{2} )$$

[symbol] Xᵢ [symbol] ^{A} is an output after passing through each attention mechanism layer, and a final output of the normalization layer is shown as follows:

LayerNorm( [symbol] X [symbol] ^{A})= [symbol] G [symbol] ^{A}/ [symbol] σ [symbol] ^{A}⊙( [symbol] Xᵢ [symbol] ^{A}− [symbol] μ [symbol] ^{A})+ [symbol] B [symbol] ^{A}
G and B are hyper-parameters in the model parameter.
3. Feedforward layer: The following calculation may be respectively performed by using the first model and the third model:

[symbol]

Z [symbol] ^{A}= [symbol] W₁ [symbol] ^{A}f( [symbol] X [symbol] ^{A} [symbol] W₀ [symbol] ^{A})

W₀ and W₁ are weight parameters in the model parameter. f(·) is an activation function, for example, may be an activation function, that is, a Gaussian error linear unit GeLu.

In the foregoing process, the first model may output first sub-feature information

$${〈 X 〉}_{0}^{A} ,$$

and the third model may output second sub-feature information

$${〈 X 〉}_{1}^{A} .$$

S607: The second device transmits the second sub-feature information to the first device, to indicate the first device to determine first data feature information based on the first sub-feature information and the second sub-feature information.
S608: The first device obtains the second sub-feature information transmitted by the second device.
S609: The first device determines the first data feature information based on the first sub-feature information and the second sub-feature information.

A combination manner of first data feature information X may be shown in the following formula:

$$X = {〈 X 〉}_{0}^{A} + {〈 X 〉}_{1}^{A}$$

S610: The first device adds noise information to the first data feature information, to obtain second data feature information.

The first device may add Gaussian noise as the noise information [symbol] (0,σ²) to the first data feature information X, where σ is a configurable parameter, to obtain second data feature information X′.
S611: The first device transmits the second data feature information and the encryption information to the second device, to instruct the second device to generate a first data processing result based on the second data feature information and the encryption information by using a second model.
S612: The second device obtains the second data feature information transmitted by the first device.
S613: The second device generates an initial data processing result based on the second data feature information by using the second model, and encrypt the initial data processing result based on the encryption information, to output the first data processing result.
S614: The second device transmits the first data processing result to the first device, to indicate the first device to decrypt the first data processing result based on the decryption information, to obtain the initial data processing result.
S615: The first device obtains the first data processing result transmitted by the second device.
S616: The first device decrypts the first data processing result based on the decryption information, to obtain the initial data processing result.

A plurality of model architectures having a similar function may be used for all models related to the present disclosure. Only one model architecture is used as an example in the embodiments of the present disclosure. This is not limited.

It can be learned from the foregoing process that, compared with the related art, the technical solutions of the present disclosure have the following technical effects:
1. In the present disclosure, a data provider cannot obtain a complete data processing model in manners such as model architecture splitting and model parameter splitting, to ensure model security of a model provider.
2. In the present disclosure, data security of the data provider can be ensured in two dimensions: input data and an output result in manners such as noise information addition, data processing result encryption, and input data sharding.
3. In the present disclosure, data processing efficiency of the data provider can be improved and data processing pressure of the data provider can be reduced in manners such as establishing an encoding mapping relationship, thereby further improving versatility of the data processing method.
4. In the present disclosure, an architecture segmentation manner and the noise information may be adjusted, to reduce impact of model architecture segmentation and noise information addition on accuracy of the data processing result, and ensure data processing accuracy.

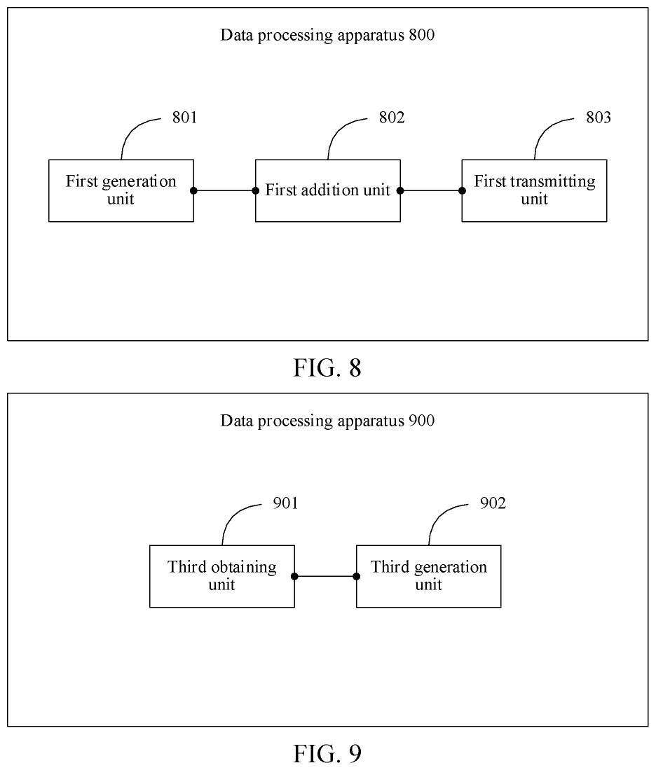

Based on the data processing method applied to the first device and that is provided in the foregoing embodiment, the present disclosure further provides a data processing apparatus. FIG. 8 is a block diagram of a structure of a data processing apparatus according to an embodiment of the present disclosure. The apparatus 800 includes a first generation unit 801, a first addition unit 802, and a first transmitting unit 803:

The first generation unit 801 is configured to generate first data feature information based on first data by using a first model, the first data feature information being configured for characterizing a data feature of the first data.

The first addition unit 802 is configured to add noise information to the first data feature information, to obtain second data feature information.

The first transmitting unit 803 is configured to transmit the second data feature information to a second device, to instruct the second device to generate a first data processing result based on the second data feature information by using a second model, the first model and the second model being configured for forming a data processing model, and the first data processing result being configured for characterizing a data processing result obtained by processing the first data by using the data processing model.

In one embodiment, the first generation unit 801 is specifically configured to:
perform sharding processing on the first data, to obtain a first data shard and a second data shard, the first data shard and the second data shard being configured for forming the first data;
generate first sub-feature information based on the first data shard by using the first model, the first sub-feature information being configured for characterizing a data feature of the first data shard, and the first model having first model parameters;
transmit the second data shard to the second device, to instruct the second device to generate second sub-feature information based on the second data shard by using a third model, the second sub-feature information being configured for characterizing a data feature of the second data shard, the third model having the same architecture as the first model, the third model having a second model parameter, the first model parameter and the second model parameter being configured for forming a target model parameter, and the target model parameter being a model parameter of the first model in the data processing model;
obtain the second sub-feature information transmitted by the second device; and
determine the first data feature information based on the first sub-feature information and the second sub-feature information.

In one embodiment, a data size of the first data shard is the same as a data size of the second data shard.

In one embodiment, the apparatus further includes a first obtaining unit, a word segmentation unit, a first determining unit, and a second generation unit.

The first obtaining unit is configured to obtain target text information.

The word segmentation unit is configured to perform word segmentation processing on the target text information, to obtain a plurality of words included in the target text information.

The first determination unit is configured to determine word encodings respectively corresponding to the plurality of words.

The second generation unit is configured to generate the first data based on the word encodings respectively corresponding to the plurality of words.

In one embodiment,
the target text information includes text information respectively corresponding to a plurality of units, and the apparatus further includes a second determination unit.

The second determination unit is configured to determine, for each of the plurality of words, a segment encoding corresponding to the word, the segment encoding being configured for characterizing a unit in which the word is located.

The second generation unit is specifically configured to:
generate the first data based on the word encodings and segment encodings that respectively correspond to the plurality of words.

In one embodiment, the apparatus further includes a third determining unit.

The third determining unit is configured to determine, for each of the plurality of words, a position encoding corresponding to the word, the position encoding being configured for characterizing a position distribution of the word in the target text information.

The second generation unit is specifically configured to:
generate the first data based on the word encodings and position encodings respectively that correspond to the plurality of words.

In one embodiment, the first determination unit is specifically configured to:
determine the word encodings respectively corresponding to the plurality of words based on an encoding mapping relationship, the encoding mapping relationship being configured for recording a mapping relationship between a word and a word encoding.

The apparatus further includes an update unit.

The update unit is configured to update the mapping relationship between a word and a word encoding into the encoding mapping relationship when the encoding mapping relationship does not include the word.

In one embodiment, the apparatus further includes a fourth determining unit.

The fourth determining unit is configured to determine encryption information and decryption information that correspond to the first data, the encryption information being configured for characterizing an encryption manner of the data processing result corresponding to the first data, and the decryption information being configured for decrypting data obtained through encryption in the encryption manner.

The first transmitting unit 803 is specifically configured to:
transmit the second data feature information and the encryption information to the second device, to instruct the second device to generate the first data processing result based on the second data feature information and the encryption information by using the second model, the second model being configured for generating an initial data processing result based on the second data feature information, and encrypting the initial data processing result based on the encryption information, to output the first data processing result.

The apparatus further includes a second obtaining unit and a decryption unit.

The second obtaining unit is configured to obtain the first data processing result transmitted by the second device.

The decryption unit is configured to decrypt the first data processing result based on the decryption information, to obtain the initial data processing result.

Based on the data processing method applied to the second device and that is provided in the foregoing embodiment, the present disclosure further provides a data processing apparatus. FIG. 9 is a block diagram of a structure of a data processing apparatus according to an embodiment of the present disclosure. The apparatus 900 includes a third obtaining unit 901 and a third generation unit 902.

The third obtaining unit 901 is configured to obtain second data feature information transmitted by a first device, the second data feature information being obtained by adding noise information to first data feature information by the first device, and the first data feature information being generated by the first device based on first data by using a first model.

The third generation unit 902 is configured to generate a first data processing result based on the second data feature information by using a second model, the first model and the second model being configured for forming a data processing model, and the first data processing result being configured for characterizing a data processing result obtained by processing the first data by using the data processing model.

In one embodiment, a difference degree between the first data processing result and a second data processing result is less than a first degree threshold, and the second data processing result is the data processing result obtained by processing the first data by using the data processing model.

In one embodiment, the apparatus further includes a fourth obtaining unit, a first segmentation unit, a fourth generation unit, a fifth generation unit, an adjustment unit, and a second segmentation unit.

The fourth obtaining unit is configured to obtain second data, the second data having a corresponding sample data processing result, and the sample data processing result being a result obtained by processing the second data by using the data processing model.

The first segmentation unit is configured to segment the data processing model in an initial structure segmentation manner, to obtain a first initial model and a second initial model.

The fourth generation unit is configured to generate third data feature information based on the second data by using the first initial model, the third data feature information being configured for characterizing a data feature corresponding to the second data.

The fifth generation unit is configured to generate a pending data processing result based on fourth data feature information by using the second initial model, the fourth data feature information being obtained by adding the noise information to the third data feature information.

The adjustment unit is configured to adjust the initial structure segmentation manner based on a difference between the pending data processing result and the sample data processing result, to obtain a structure segmentation manner, a difference degree between the pending data processing result and the sample data processing result that are determined in the structure segmentation manner being less than a first degree threshold.

The second segmentation unit is configured to segment the data processing model in the structure segmentation manner, to obtain the first model and the second model.

In one embodiment, the noise information meets that the difference degree between the first data processing result and the second data processing result is less than a second degree threshold, and the second data processing result is the data processing result obtained by processing the first data by using the data processing model.

In one embodiment, the first device is further configured to perform sharding processing on the first data, to obtain a first data shard and a second data shard, the first data shard and the second data shard being configured for forming the first data, the second device further including a third model, the third model having the same architecture as the first model, the third model having a second model parameter, and the apparatus further including a fifth obtaining unit, a sixth generation unit, and a second transmitting unit.

The fifth obtaining unit is configured to obtain the second data shard transmitted by the first device.

The sixth generation unit is configured to generate second sub-feature information based on the second data shard by using the third model.

The second transmitting unit is configured to transmit the second sub-feature information to the first device, to indicate the first device to determine the first data feature information based on first sub-feature information and the second sub-feature information, the first sub-feature information being feature information generated by the first device based on the first data shard by using the first model, the first model having a first model parameter, the first model parameter and the second model parameter being configured for forming a target model parameter, and the target model parameter being a model parameter of the first model in the data processing model.

In one embodiment, the third obtaining unit 901 is specifically configured to:
obtain the second data feature information and encryption information that are transmitted by the first device, the encryption information being configured for characterizing an encryption manner of a data processing result corresponding to the first data.

The third generation unit 902 is specifically configured to: generate an initial data processing result based on the second data feature information by using the second model, and encrypt the initial data processing result based on the encryption information, to output the first data processing result.

The apparatus further includes a third transmitting unit.

The third transmitting unit is configured to transmit the first data processing result to the first device, to indicate the first device to decrypt the first data processing result based on decryption information, so as to obtain the initial data processing result, the decryption information being configured for decrypting data obtained through encryption in the encryption manner.

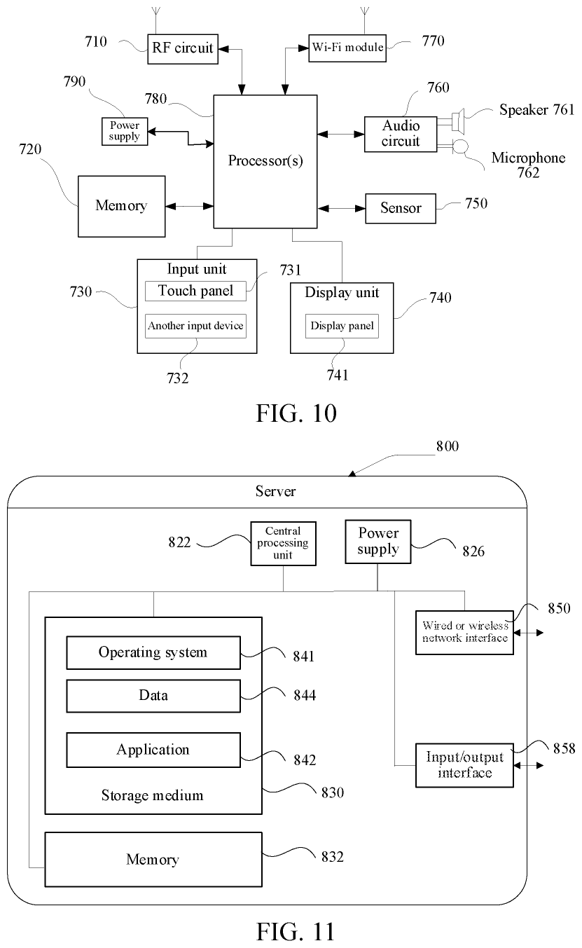

An embodiment of the present disclosure further provides a computer device. With reference to FIG. 10, the computer device may be a terminal device. Using an example in which the terminal device is a mobile phone.

FIG. 10 is a block diagram of a partial structure of a mobile phone related to the terminal device according to an embodiment of the present disclosure. With reference to FIG. 10, the mobile phone includes: a radio frequency (RF for short) circuit 710, a memory 720, an input unit 730, a display unit 740, a sensor 750, an audio circuit 760, a wireless fidelity (Wi-Fi for short) module 770, a processor 780, a power supply 790, and another component. A person skilled in the art may understand that the structure of the mobile phone shown in FIG. 10 does not constitute a limitation to the mobile phone. The mobile phone may include more or fewer components than those shown in the figure, or combine certain components, or have different component arrangements.

The following specifically describes the components of the mobile phone with reference to FIG. 10.

The RF circuit 710 is configured to receive and transmit signals in an information receiving and transmitting process or a call process. In particular, after receiving downlink information from a base station, the RF circuit 710 provides the downlink information to the processor 780 for processing. In addition, the RF circuit 710 transmits data designed for uplink to the base station. Generally, the RF circuit 710 includes, but is not limited to, an antenna, at least one amplifier, a transceiver, a coupler, a low noise amplifier (LNA for short), a duplexer, and the like. In addition, the RF circuit 710 may further communicate with a network and another device by using wireless communication. The wireless communication may use any communication standard or protocol, including but not limited to a global system of mobile communication (GSM for short), a general packet radio service (GPRS for short), a code division multiple access (CDMA for short), a wideband code division multiple access (WCDMA for short), a long term evolution (LTE for short), an email, a short messaging service (SMS for short), and the like.

The memory 720 may be configured to store a software program and a module. The processor 780 executes various function applications and data processing of the mobile phone by running the software program and the module stored in the memory 720. The memory 720 may mainly include a program storage region and a data storage region. The program storage region may store an operating system, an application program required by at least one function (such as a sound play function and an image play function), and the like. The data storage region may store data created based on use of the mobile phone (such audio data, a phone book), and the like. In addition, the memory 720 may include a high-speed random access memory, and may also include a non-volatile memory such as at least one magnetic disk storage device, a flash memory, or another volatile solid-state storage component.

The input unit 730 is configured to receive input digit or character information, and generate key signal inputs related to user settings and function control of the mobile phone. Specifically, the input unit 730 may include a touch panel 731 and anther input device 732. The touch panel 731, also referred to as a touch screen, may collect a touch operation performed by a user on or closer to the touch screen (such as, an operation performed by the user on or closer to the touch panel 731 using any suitable object or accessory such as a finger or a stylus), and drive a corresponding connection device based on a preset program. In some embodiments, the touch panel 731 may include two parts: a touch detection device and a touch controller. The touch detection device detects a touch orientation of the user, detects a signal brought by the touch operation, and transmits the signal to the touch controller. The touch controller receives touch information from the touch detection device, converts the touch information into a touch point coordinate, transmits the touch point coordinate to the processor 780, and can receive a command transmitted by the processor 780 and execute the command. In addition, the touch panel 731 may be implemented by using various types such as resistive, capacitive, infrared, and surface acoustic wave. In addition to the touch panel 731, the input unit 730 may further include another input device 732. Specifically, the another input device 732 may include, but is not limited to, one or more of a physical keyboard, a function key (such as a volume control key, or a switch key), a trackball, a mouse, and a joystick.

The display unit 740 is configured to display information inputted by the user or information provided for the user, and various menus of the mobile phone. The display unit 740 may include a display panel 741. In some embodiments, the display panel 741 may be configured in forms such as a liquid crystal display (LCD for short), or an organic light-emitting diode (OLED for short). Further, the touch panel 731 may cover the display panel 741. When the touch panel 731 detects the touch operation on or closer to the touch panel 731, the touch panel 731 transmits the signal to the processor 780 to determine a type of a touch event, and subsequently, the processor 780 provides a corresponding visual output on the display panel 741 based on the type of the touch event. Although the touch panel 731 and the display panel 741 are used as two independent components to implement input and output functions of the mobile phone in FIG. 10, in some embodiments, the touch panel 731 and the display panel 741 may be integrated to implement the input and output functions of the mobile phone.

The mobile phone may further include at least one sensor 750 such as an optical sensor, a motion sensor, and another sensor. Specifically, the optical sensor may include an ambient light sensor and a proximity sensor. The ambient light sensor may adjust brightness of the display panel 741 based on an intensity of an ambient light, and the proximity sensor may turn off the display panel 741 and/or back light when the mobile phone is moved to an ear. As one type of the motion sensor, an accelerometer sensor may detect magnitude of acceleration in various directions (typically three axes). When the mobile phone is stationary, magnitude and a direction of gravity can be detected, and the accelerometer sensor can be configured for an application (such as switching between landscape and portrait screens, a related game, and magnetometer pose calibration) for recognizing a mobile phone pose, a vibration recognition related function (such as a pedometer and a knock), and the like. As for another sensor such as a gyroscope, a barometer, a hygrometer, a thermometer, and an infrared sensor that may be further configured in the mobile phone, details are not described herein again.

The audio circuit 760, a speaker 761, and a microphone 762 may provide an audio interface between the user and the mobile phone. The audio circuit 760 may transmit an electrical signal obtained by converting received audio data to the speaker 761, and the speaker 761 converts the electrical signal into a sound output signal. On the other hand, the microphone 762 converts a collected sound signal into an electrical signal, which is received by the audio circuit 760 and converted into audio data. Then, the audio data is outputted to the processor 780 for processing and transmitted to, for example, another mobile phone, or the audio data is outputted to the memory 720 for further processing.

Wi-Fi belongs to short-range wireless transmission technology. The mobile phone assists the user in transmitting and receiving an email, browsing a web page, accessing streaming media, and the like. Through the Wi-Fi module 770, the user is provided with wireless broadband Internet access. Although FIG. 10 shows the Wi-Fi module 770, the Wi-Fi module 770 is not an essential component of the mobile phone and may be omitted as required within the scope of not changing the essence of the invention.

The processor 780 is a control center of the mobile phone, connects various parts of an entire mobile phone through various interfaces and lines, and executes various functions of the mobile phone and processes data by running or executing the software programs and/or the modules stored in the memory 720 and calling data stored in the memory 720, thereby performing overall detection on the mobile phone. In some embodiments, the processor 780 may include one or more processing cores. In some exemplary embodiments, the processor 780 may integrate an application processor and a modem processor. The application processor mainly processes the operating system, a user interface, an application program, and the like. The modem processor mainly processes wireless communication. The foregoing modem processor may alternatively not be integrated into the processor 780.

The mobile phone further includes the power supply 790 (such as a battery) for supplying power to various components. In some exemplary embodiments, the power supply may be logically connected to the processor 780 by using a power management system, thereby implementing functions such as charging, discharging, and power consumption management by using the power management system.

Although not shown in the figure, the mobile phone may further include a camera, a Bluetooth module, and the like. Details are not described herein.

In this embodiment, the processor 780 included in the terminal device is further configured to perform the foregoing data processing method on a first device side or a second device side.

An embodiment of the present disclosure further provides a server. FIG. 11 is a diagram of a structure of a server 800 according to an embodiment of the present disclosure. The server 800 may have large differences due to different configurations or performances, and may include one or more central processing units 822 (CPU for short) (such as one or more processors), a memory 832, and one or more storage media 830 (such as one or more mass storage devices) having an application 842 or data 844 stored therein. The memory 832 and the storage medium 830 may be transient storage or persistent storage. The program stored in the storage medium 830 may include one or more modules (not shown in the figure), and each module may include a series of instruction operations for the server. Further, the central processing unit 822 may be configured to communicate with the storage medium 830 and execute the series of instruction operations in the storage medium 830 on the server 800.

The server 800 may further include one or more power supplies 826, one or more wired or wireless network interfaces 850, one or more input/output interfaces 858, and/or one or more operating systems 841.

Operations performed by the server in the foregoing embodiment may be based on the structure of the server shown in FIG. 11.

An embodiment of the present disclosure further provides a computer-readable storage medium, configured to store a computer program. The computer program is configured for performing any one of implementation in the data processing methods according to the foregoing embodiments.

An embodiment of the present disclosure further provides a computer program product including a computer program. The computer program product, when running on a computer device, enables the computer device to perform the data processing method according to any one of the foregoing embodiments.

As disclosed, to prevent the first device used as the data provider from obtaining a complete data processing model, in the present disclosure, only the first model on an input side in the data processing model may be placed in the first device, in other words, the data provider can obtain only a part of the model, thereby ensuring security of the model. The first device may generate the first data feature information based on the first data used as input data by using the first model. Secondly, to prevent the second device used as the model provider from obtaining the first data, the first device may add the noise information to the first data feature information, to obtain the second data feature information, and transmit the second data feature information to the second device, to instruct the second device to determine the first data processing result by using the second model on an output side in the data processing model. The first data processing result is configured for characterizing the data processing result obtained by processing the first data by using the data processing model. Because the second data feature information includes the noise information, the second device cannot accurately restore the first data based on the second data feature information, thereby ensuring that the input data provided by the data provider is not obtained by the model provider, and ensuring the security of the data. Meanwhile, because the noise information affects a data processing process in the second model on an output side, a degree of impact of the data processing process is small, thereby ensuring that a finally obtained first data processing result is closer to an actual data processing result obtained by processing the first data by using the data processing model, and ensuring the data processing accuracy. In conclusion, in the present disclosure, the security of the data for the data provider and the security of the model of the model provider can be ensured while the data processing accuracy is ensured. In addition, no data processing procedure needs to be repeated for a plurality of times, so that a computational workload required for an overall data processing process is reduced, and the data processing efficiency is ensured. Therefore, the data processing method of the present disclosure can be applicable to the wider range of data processing scenarios.

In a specific implementation of the present disclosure, data related to user information (such as data of a data provider) exists. When the foregoing embodiments of the present disclosure are applied to specific products or technologies, user permission or consent needs to be obtained, and collection, use, and processing of related data need to comply with related laws, regulations, and standards of related countries and regions.

A person of ordinary skill in the art may understand that, all or some of the operations of the foregoing method embodiments may be implemented by hardware related to program instructions. The foregoing program may be stored in a computer-readable storage medium. When the program is executed, the operations of the foregoing method embodiments are performed. The foregoing storage medium may be at least one of the following media: a read-only memory (ROM for short), a random access memory (RAM), a magnetic disk, an optical disc, or various other media that can store the computer program.

The various embodiments in this specification are described in a progressive manner. Same or similar parts in the various embodiments can be cross-referenced, and descriptions of each embodiment focus on differences from other embodiments. In particular, for the device and system embodiments, the device and system embodiments are basically similar to the method embodiments and therefore are only briefly described, and refer to the method embodiments for the related part. The device and system embodiments described above are merely exemplary. Units described as separate components may or may not be physically separated, and components displayed as units may or may not be physical units, in other words, the components may be located in one place, or may be distributed on a plurality of network units. Some or all of the modules may be selected to implement the objective of the solution of this embodiment based on an actual requirement. A person of ordinary skill in the art may understand and implement the embodiments of the present disclosure without creative efforts.

As used herein, the term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing descriptions are merely a specific implementation of the present disclosure, and the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A data processing method performed by a first device, the method comprising:
generating first data feature information based on first data using a first model, the first data feature information being configured for characterizing a data feature of the first data;
adding noise information to the first data feature information, to obtain second data feature information; and
transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

2. The method according to claim 1, wherein generating the first data feature information based on the first data using the first model comprises:
performing sharding processing on the first data, to obtain a first data shard and a second data shard, the first data shard and the second data shard being configured for forming the first data;
generating first sub-feature information based on the first data shard by the first model, the first sub-feature information being configured for characterizing a data feature of the first data shard, and the first model having a first model parameter;
transmitting the second data shard to the second device, to instruct the second device to generate second sub-feature information based on the second data shard using a third model, the second sub-feature information being configured for characterizing a data feature of the second data shard, the third model having same architecture as the first model, the third model having a second model parameter, the first model parameter and the second model parameter being configured for forming a target model parameter, and the target model parameter being a model parameter of the first model in the data processing model;
obtaining the second sub-feature information transmitted by the second device; and
determining the first data feature information based on the first sub-feature information and the second sub-feature information.

3. The method according to claim 2, wherein a data size of the first data shard is same as a data size of the second data shard.

4. The method according to claim 1, further comprising:
obtaining target text information for processing;
performing word segmentation processing on the target text information, to obtain a plurality of words comprised in the target text information;
determining word encodings respectively corresponding to the plurality of words; and
generating the first data based on the word encodings respectively corresponding to the plurality of words.

5. The method according to claim 4, wherein the target text information comprises text information respectively corresponding to a plurality of units, and the method further comprises:
determining, for a word of the plurality of words, a segment encoding corresponding to the word, the segment encoding being configured for characterizing a unit in which the word is located; and
generating the first data based on the word encodings respectively corresponding to the plurality of words comprises:
generating the first data based on the word encodings and segment encodings that respectively correspond to the plurality of words.

6. The method according to claim 4, further comprising:
determining, for a word of the plurality of words, a position encoding corresponding to the word, the position encoding being configured for characterizing a position distribution of the word in the target text information; and
generating the first data based on the word encodings respectively corresponding to the plurality of words comprises:
generating the first data based on the word encodings and position encodings that respectively correspond to the plurality of words.

7. The method according to claim 4, wherein determining the word encodings respectively corresponding to the plurality of words comprises:
determining the word encodings respectively corresponding to the plurality of words based on an encoding mapping relationship, the encoding mapping relationship being configured for recording a mapping relationship between a word and a word encoding; and
the method further comprises:
updating the mapping relationship between a word and a word encoding into the encoding mapping relationship when the encoding mapping relationship does not comprise the word.

8. The method according to claim 1, further comprising:
determining encryption information and decryption information that correspond to the first data, the encryption information being configured for characterizing an encryption manner of the data processing result corresponding to the first data, and the decryption information being configured for decrypting data obtained through encryption in the encryption manner,
wherein
transmitting the second data feature information to the second device, to instruct the second device to generate the first data processing result based on the second data feature information using the second model comprises:
transmitting the second data feature information and the encryption information to the second device, to instruct the second device to generate the first data processing result based on the second data feature information and the encryption information by using the second model, the second model being configured for generating an initial data processing result based on the second data feature information, and encrypting the initial data processing result based on the encryption information, to output the first data processing result.

9. The method according to claim 8, further comprising:
obtaining the first data processing result transmitted by the second device; and
decrypting the first data processing result based on the decryption information, to obtain the initial data processing result.

10. An electronic device used as a first device, comprising:
one or more processors and a memory containing a computer program that, when being executed, causes the one or more processors to perform:
generating first data feature information based on first data using a first model, the first data feature information being configured for characterizing a data feature of the first data;
adding noise information to the first data feature information, to obtain second data feature information; and
transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

11. The electronic device according to claim 10, wherein the one or more processors are further configured to perform:
performing sharding processing on the first data, to obtain a first data shard and a second data shard, the first data shard and the second data shard being configured for forming the first data;
generating first sub-feature information based on the first data shard by the first model, the first sub-feature information being configured for characterizing a data feature of the first data shard, and the first model having a first model parameter;
transmitting the second data shard to the second device, to instruct the second device to generate second sub-feature information based on the second data shard using a third model, the second sub-feature information being configured for characterizing a data feature of the second data shard, the third model having same architecture as the first model, the third model having a second model parameter, the first model parameter and the second model parameter being configured for forming a target model parameter, and the target model parameter being a model parameter of the first model in the data processing model;
obtaining the second sub-feature information transmitted by the second device; and
determining the first data feature information based on the first sub-feature information and the second sub-feature information.

12. The electronic device according to claim 11, wherein a data size of the first data shard is same as a data size of the second data shard.

13. The electronic device according to claim 10, wherein the one or more processors are further configured to perform:
obtaining target text information for processing;
performing word segmentation processing on the target text information, to obtain a plurality of words comprised in the target text information;
determining word encodings respectively corresponding to the plurality of words; and
generating the first data based on the word encodings respectively corresponding to the plurality of words.

14. The electronic device according to claim 13, wherein the target text information comprises text information respectively corresponding to a plurality of units, and the one or more processors are further configured to perform:
determining, for a word of the plurality of words, a segment encoding corresponding to the word, the segment encoding being configured for characterizing a unit in which the word is located; and
generating the first data based on the word encodings and segment encodings that respectively correspond to the plurality of words.

15. The electronic device according to claim 13, wherein the one or more processors are further configured to perform:
determining, for a word of the plurality of words, a position encoding corresponding to the word, the position encoding being configured for characterizing a position distribution of the word in the target text information; and
generating the first data based on the word encodings and position encodings that respectively correspond to the plurality of words.

16. The electronic device according to claim 13, wherein the one or more processors are further configured to perform:
determining the word encodings respectively corresponding to the plurality of words based on an encoding mapping relationship, the encoding mapping relationship being configured for recording a mapping relationship between a word and a word encoding; and
updating the mapping relationship between a word and a word encoding into the encoding mapping relationship when the encoding mapping relationship does not comprise the word.

17. The electronic device according to claim 10, wherein the one or more processors are further configured to perform:
determining encryption information and decryption information that correspond to the first data, the encryption information being configured for characterizing an encryption manner of the data processing result corresponding to the first data, and the decryption information being configured for decrypting data obtained through encryption in the encryption manner; and
transmitting the second data feature information and the encryption information to the second device, to instruct the second device to generate the first data processing result based on the second data feature information and the encryption information by using the second model, the second model being configured for generating an initial data processing result based on the second data feature information, and encrypting the initial data processing result based on the encryption information, to output the first data processing result.

18. The electronic device according to claim 17, wherein the one or more processors are further configured to perform:
obtaining the first data processing result transmitted by the second device; and
decrypting the first data processing result based on the decryption information, to obtain the initial data processing result.

19. A non-transitory computer readable storage medium containing a computer program that, when being executed, causes at least one processor to perform:
generating first data feature information based on first data using a first model, the first data feature information being configured for characterizing a data feature of the first data;
adding noise information to the first data feature information, to obtain second data feature information; and
transmitting the second data feature information to a second device, to instruct the second device to generate a first data processing result based on the second data feature information using a second model, the first model and the second model being configured for forming a data processing model, and the first data processing result being configured for characterizing a data processing result obtained by processing the first data using the data processing model.

20. The storage medium according to claim 19, wherein the at least one processor is further configured to perform:
performing sharding processing on the first data, to obtain a first data shard and a second data shard, the first data shard and the second data shard being configured for forming the first data;
generating first sub-feature information based on the first data shard by the first model, the first sub-feature information being configured for characterizing a data feature of the first data shard, and the first model having a first model parameter;
transmitting the second data shard to the second device, to instruct the second device to generate second sub-feature information based on the second data shard using a third model, the second sub-feature information being configured for characterizing a data feature of the second data shard, the third model having same architecture as the first model, the third model having a second model parameter, the first model parameter and the second model parameter being configured for forming a target model parameter, and the target model parameter being a model parameter of the first model in the data processing model;
obtaining the second sub-feature information transmitted by the second device; and
determining the first data feature information based on the first sub-feature information and the second sub-feature information.
